(19) United States
(12) Patent Application Publication
(10) Pub. No.: US 2013/0258329 A1
(43) Pub. Date: Oct. 3, 2013

(54) Inspection Apparatus, Inspection Method and Program for Inspection

(71) Applicant: SEIKO EPSON CORPORATION, Tokyo (JP)

(72) Inventors: Yu HIGUCHI, Shiojiri-shi (JP); Seiji IZUO, Shiojiri-shi (JP)

(73) Assignee: SEIKO EPSON CORPORATION, Tokyo (JP)

(21) Appl. No.: 13/845,858

(22) Filed: Mar. 18, 2013

(30) Foreign Application Priority Data
Apr. 3, 2012 (JP) 2012-084608

(51) Int. Cl. G01N 21/88

(52) U.S. Cl. CPC G01N 21/8806
USPC 356/237.4

(57) ABSTRACT

In a first platen gap, a light emitting amount is decided to obtain a light receiving amount for inspection as a first light emitting amount for inspection. Subsequently, in a second platen gap, a light emitting amount is decided to obtain a light receiving amount for inspection as a second light emitting amount for inspection. An inspection on dot forming is performed, using a smaller light emitting amount for inspection between the first and second light emitting amounts for inspection, and using the platen gap in which the smaller light emitting amount for inspection is decided.

### CROSS-REFERENCE TO RELATED APPLICATIONS

The entire disclosure of Japanese Patent Application No.2012-084608, filed Apr. 3, 2012 is expressly incorporated by reference herein.

### BACKGROUND

1. Technical Field

The present invention relates to inspection of dot forming.

2. Related Art

A method is known in which, as inspection on whether or not a dot is formed normally by a printer, light is emitted toward a position where the dot is supposed to be formed and then a light receiving amount is measured when reflected light is received by a light receiving element (for example, JP-A-2005-59553).

A technology disclosed in JP-A-2005-59553 is a technology by which an accuracy of the inspection is increased by adjusting a distance from a sheet to the light receiving element to a predetermined value. Since the light receiving amount of the reflected light generally depends upon the distance from the sheet to the light receiving element, it is preferable to perform such an adjustment. The predetermined value described above is a distance where the light receiving amount hardly varies even though a light receiving distance varies due to cockling. The cockling is a phenomenon in which a printing medium undulates like a wave.

A disadvantage in the above-described related art is that a decreased light emitting amount upon inspection is not considered. A large light emitting amount shortens a durability of the light emitting element and causes an unnecessary consumption of power.

### SUMMARY

The invention can be realized in the following embodiments or the application examples.

### APPLICATION EXAMPLE 1

An inspection apparatus includes a first decision unit that decides a first light emitting amount for inspection to obtain a light receiving amount for inspection, in a first platen gap, a second decision unit that decides a second light emitting amount for inspection to obtain a light receiving amount for inspection, in a second platen gap, an inspection unit that performs the inspection of dot forming, using a smaller light emitting amount for inspection between the first and second light emitting amounts for inspection, and using the platen gap in which the smaller light emitting amount for inspection is decided.

According to this application example, since the inspection is performed using the smaller value of the light emitting amount, the light emitting amount used in the inspection can be decreased.

### APPLICATION EXAMPLE 2

The inspection apparatus according to application example 1 includes, in a case where any of the first and second light emitting amounts for inspection is not decided, a third decision unit that decides a third light emitting amount for inspection, in a third platen gap. The inspection unit performs, in a case where the third light emitting amount for inspection is decided, the inspection using the third light emitting amount for inspection and the third platen gap.

According to this application example, even in a case where the light emitting amount for inspection in any of the first and second platen gap is not decided, if the light emitting amount for inspection in the third platen gap can be decided, the light receiving amount for inspection can be obtained.

### APPLICATION EXAMPLE 3

The inspection apparatus according to application example 1 or 2, in which the second decision unit changes whether or not to decide the second light emitting amount for inspection based on the light receiving amount rate in the first platen gap, and in which the inspection unit performs the inspection using the first light emitting amount for inspection and the first platen gap, in a case where the second light emitting amount for inspection is not decided by the second decision unit.

According to this application example, in a case where a better light receiving amount rate than the predetermined value can be obtained in the first platen gap, since a determination to decide the second light emitting amount for inspection can be omitted, a time and light emitting which are required for determination can be saved. The light receiving amount rate is a standardized value obtained by dividing the light receiving amount by the light emitting amount.

### APPLICATION EXAMPLE 4

An inspection method includes deciding a first light emitting amount for inspection to obtain a light receiving amount for inspection in a first platen gap; deciding a second light emitting amount for inspection to obtain a light receiving amount for inspection in a second platen gap; and performing an inspection on dot forming using a smaller light emitting amount for inspection between the first and second light emitting amounts for inspection, and a platen gap in which the smaller light emitting amount for inspection is decided.

According to this application example, a similar effect to that of application example 1 can be obtained.

### APPLICATION EXAMPLE 5

A program that causes the inspection apparatus to perform; a first decision procedure which decides a first light emitting amount for inspection to obtain a light receiving amount for inspection in a first platen gap, a second decision procedure which decides a second light emitting amount for inspection to obtain a light receiving amount for inspection in a second platen gap, an inspection procedure which performs an inspection on dot forming using a smaller light emitting amount for inspection between the first and second light emitting amounts for inspection, and a platen gap in which the smaller light emitting amount for inspection is decided.

According to this application example, a similar effect to that of application example 1 can be obtained.

Any of the application examples described above can be realized in various forms. For example, a printing apparatus in which the inspection apparatus is incorporated may be considered.

### BRIEF DESCRIPTION OF THE DRAWINGS

The invention will be described with reference to the accompanying drawings, wherein like numbers reference like elements.

FIGS. 1A and 1B are external views illustrating a printer.

FIG. 2 is a block diagram illustrating an electric configuration of the printer.

FIG. 3 is a flow chart illustrating an inspection process.

FIG. 4 is a graph illustrating a relationship between a light receiving amount rate and a detection distance.

### DESCRIPTION OF EXEMPLARY EMBODIMENTS

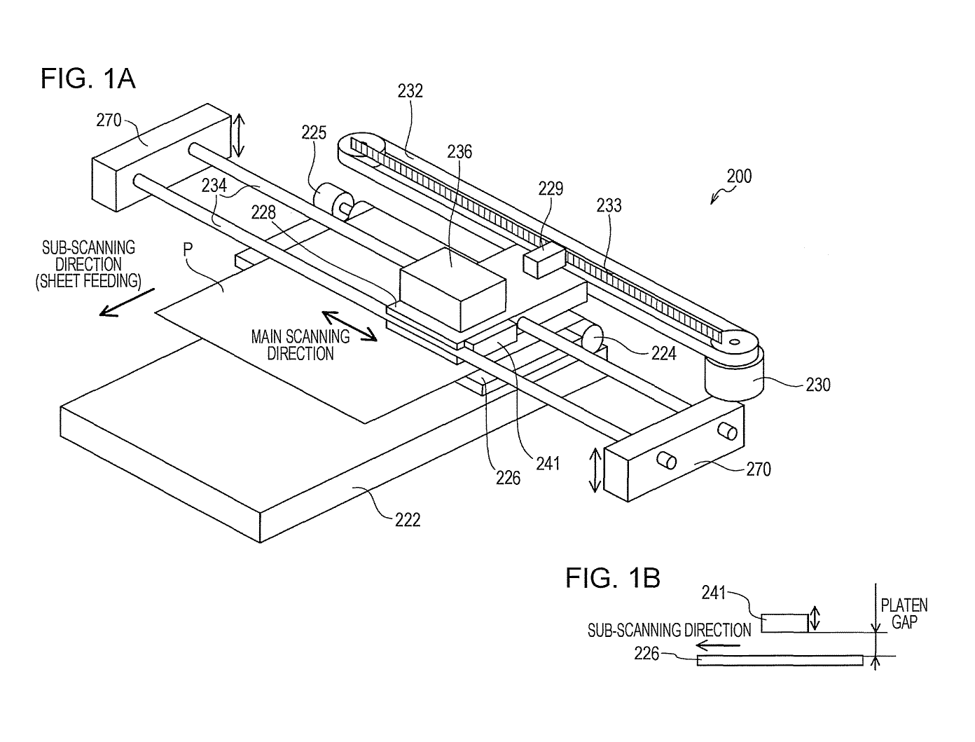

### 1. Schematic Configuration of Printer 200 (FIGS. 1A and 1B)

FIG. 1A is a perspective view illustrating a printer 200. As illustrated in FIGS. 1A and 1B, the printer 200 includes a sheet stacker 222, a transportation roller 224, a platen plate 226, a carriage 228, a carriage motor 230, a traction belt 232 and a platen gap adjustment mechanism 270. The carriage 228 is equipped with a linear encoder 229, a printing head 236 and an optical sensor 241.

The sheet stacker 222 feeds a printing sheet P using a sheet feeding roller (not illustrated). The transportation roller 224 is driven by a motor (not illustrated) and transports the printing sheet P in a sub-scanning direction on the surface of the platen plate 226.

On the shaft of the transportation roller 224, a rotary encoder 225 is provided. The rotary encoder 225 outputs a signal corresponding to a rotation amount of the transportation roller 224 and consequently to a transportation amount of the printing sheet P. The transportation of the printing sheet P is controlled based on the output.

The carriage motor 230 drives the traction belt 232. By the drive of the traction belt, the carriage 228 scans in a main scanning direction (the direction orthogonal to the sub-scanning direction). A guide rail 234 guides the scanning of the carriage 228.

The linear encoder 229 is intended to read a sign on a sign plate 233 by an optical method. The read result is used for detecting the position of the carriage 228 in the main scanning direction.

The printing head 236 includes a plurality of nozzle arrays. Each of the plurality of nozzle arrays is formed from a plurality of nozzles disposed along the sub-scanning direction. The printing is realized by ejecting ink from each nozzle.

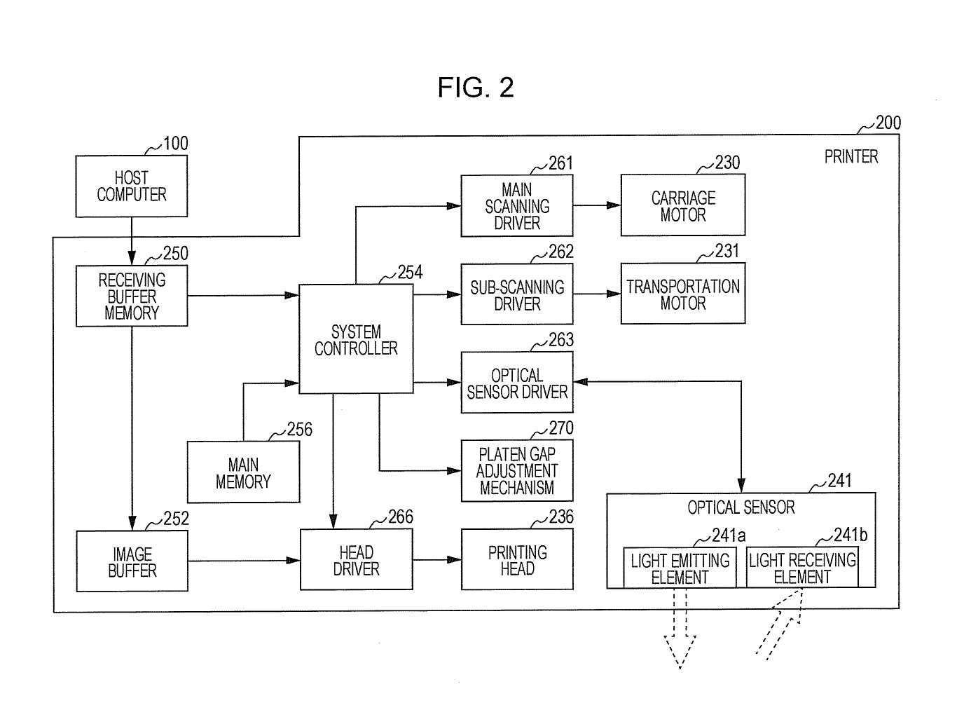

An optical sensor 241 includes a light emitting element 241a and a light receiving element 241b (refer to FIG. 2). The light emission from the light emitting element 241a and the light reception by the light receiving element 241b are performed for dot inspection to be described below.

The platen gap adjustment mechanism 270 is driven by a motor (not illustrated) and moves two guide rails 234 in a vertical direction without changing the mutual positional relationships, as illustrated in FIG. 1A. When moving in the vertical direction, there is no movement in the directions other than the vertical direction. The vertical direction here is a direction orthogonal to both the main scanning direction and the sub-scanning direction. When the guide rails 234 move in the vertical direction, the optical sensor 241 included in the carriage 228 moves in the vertical direction with respect to the platen plate 226 and hence the platen gap is adjusted.

FIG. 1B is a diagram when the platen plate 226 and the optical sensor 241 are seen with the main scanning direction as a viewing direction. The platen gap is a distance between a lower surface of the optical sensor 241 and an upper surface of the platen plate 226, as illustrated in FIG. 1B. In the printer 200, the platen gap may be adjusted to a range of 1.5 mm to 2.5 mm. In addition, the optical sensor 241 is disposed so that the lower surface of the optical sensor 241 matches the lower surface of the printing head 236.

### 2. Electric Configuration of Printer 200 (FIG. 2)

FIG. 2 is a block diagram illustrating an electric configuration of the printer 200. A host computer 100 determines various parameter values which specify a printing operation, based on a printing mode designated by a user (a high speed printing mode, a high definition printing mode and the like). The host computer 100 generates printing data for printing, based on those parameters, and transfers the data to the printer 200.

In addition to the description with FIGS. 1A and 1B, as illustrated in FIG. 2, the printer 200 includes a receiving buffer memory 250, an image buffer 252, a system controller 254, a main memory 256, a main scanning driver 261, a sub-scanning driver 262, an optical sensor driver 263 and a head driver 266.

The system controller 254 controls all the operations of the printer 200. The receiving buffer memory 250 receives the printing data supplied from the host computer 100. The image buffer 252 stores the data received by the receiving buffer memory 250. The stored data here is the printing data having a plurality of color components obtained by decomposing the printing data received in the receiving buffer memory 250 for each color component.

The system controller 254 reads out the necessary information from the printing data stored in the receiving buffer memory 250 and sends a control signal to each of the drivers based on the information.

The main scanning driver 261 drives the carriage motor 230. The sub-scanning driver 262 drives a transportation motor 231. The head driver 266 reads out the printing data having each color component from the image buffer 252 according to the control signal from the system controller 254, and drives the nozzles of each color accordingly.

The optical sensor 241 includes the light emitting element 241a and the light receiving element 241b as illustrated in FIG. 2. The optical sensor driver 263 controls the optical sensor 241. Specifically, the optical sensor driver 263 adjusts a light emitting amount of the light emitting element 241a and measures an electric current from the light receiving element 241b. This control is realized such that the system controller 254 controls the optical sensor driver 263.

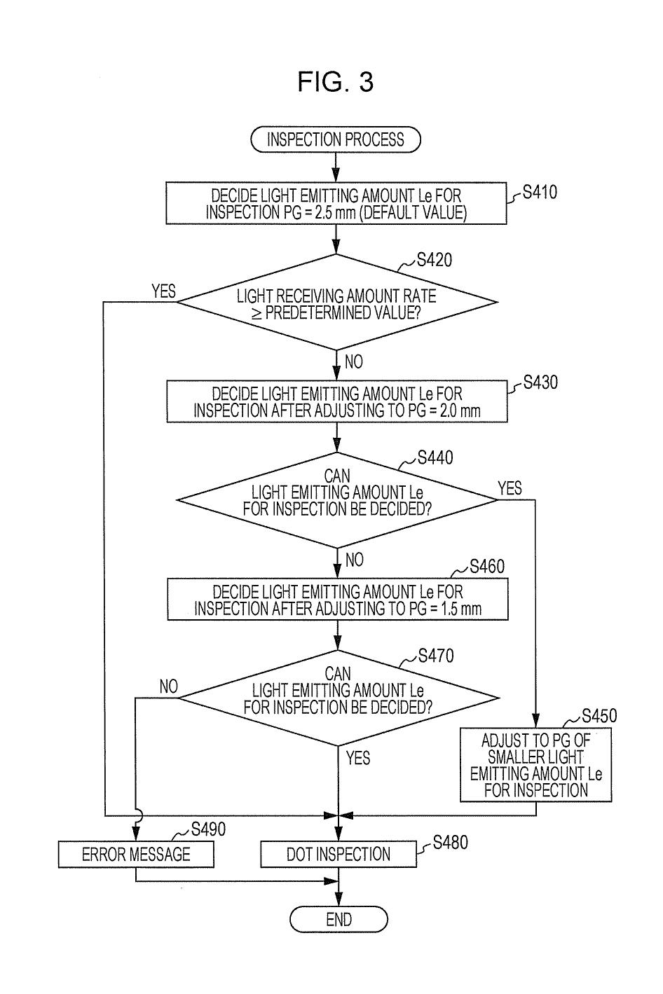

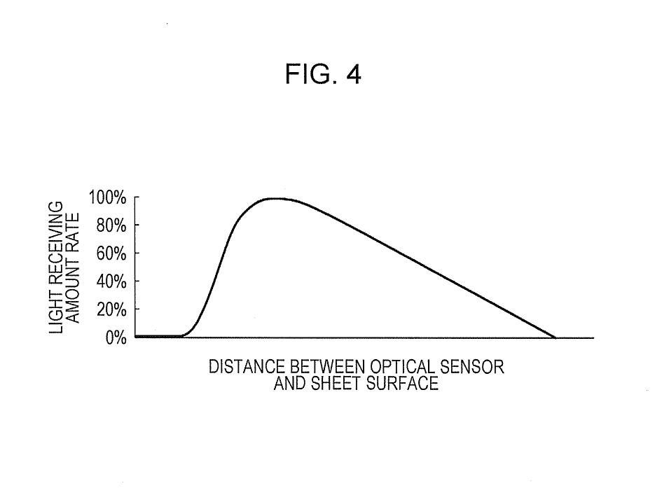

### 3. Inspection Process (FIGS. 3 and 4)

FIG. 3 is a flow-chart illustrating an inspection process. An execution subject of the inspection process is the system controller 254. The inspection process is executed periodically. Specifically, the inspection process is executed when a predetermined number of printing sheets P is printed, counted from the previous execution of the inspection process. For example, in a case where the printing is continuously performed on a number of sheets, or when the printing is performed on the predetermined number of sheets, the printing is stopped and the inspection process is executed.

First, a light emitting amount Le for inspection is decided (STEP S410). Specifically, by changing the light emitting amount emitted from the light emitting element 241a through changing the electric current value flowing in the light emitting element 241a, the light emitting amount at the time when a light receiving amount Lr for inspection is obtainable, is decided as the light emitting amount Le for inspection. The light receiving amount Lr for inspection is a predetermined value as a light amount to perform a dot inspection in STEP S480. In the dot inspection, whether or not a dot is formed on a certain region is determined, or a state and a density of the formed dot are determined, using the light amount reflected from the region where the light is emitted. In order to perform this determination, it is preferable that the difference is large between the reflected light amount at the region where the dot is not formed (hereafter, referred to as “a light amount without a dot”) and the reflected light amount at the region where the dot is formed. In order to make the difference large, the light amount without the dot may be increased. In order to increase the light amount without the dot, the light emitting amount may be increased. However, if the light emitting amount is excessively increased, the durability of the light emitting element 241a is shortened and the power is excessively consumed. Therefore, the light receiving amount Lr for inspection is decided to be such a minimum value that the dot inspection can be executed normally. In this way, it is possible to make the light emitting amount Le for inspection as small a value as possible.

The platen gap in STEP S410 is 2.5 mm as a default value at the time of inspection process. Depending on the conditions, there is a case where the decision in STEP S410 may not be possible. A description with regard to this will be made with reference to FIG. 4.

FIG. 4 is a graph illustrating a relationship between a light receiving amount rate and a distance from the light receiving element 241b to the printing sheet P (hereafter, referred to as “a detection distance”). In the graph, while keeping the light emitting amount from the light emitting element 241a constant, in a case where the distance between the optical sensor 241 and the sheet surface is changed, the change of the light receiving amount by the light receiving element 241b can be appreciated. The light receiving amount rate is a standardized value obtained by dividing the light receiving amount by the light emitting amount. As illustrated in FIG. 4, the light receiving amount rate has a single peak and monotonically decreases according to the departing distance from the peak. In addition, in a case where the detection distance is increased with a starting point as the peak, the light receiving amount rate gradually decreases compared to a case where the detection distance is decreased.

The detection distance corresponds to a value obtained by subtracting the thickness of the sheet from the platen gap. Accordingly, the detection distance depends on the thickness of the sheet. In addition, since there is a case where the platen gap may have a value different from the target value due to an assembling error, the detection distance also depends on the assembling error. For these reasons, it is considered that the light receiving amount Lr for inspection cannot be obtained even by the maximum light emitting amount, in a case where the detection distance is greatly deviated from a value where the light receiving amount rate is peak. Consequently in a case where the light receiving amount Lr for inspection cannot be obtained even by the maximum light emitting amount, the light emitting amount Le for inspection is not decided in STEP S410.

Subsequently, in the current platen gap (=2.5 mm), it is determined whether or not the light receiving amount rate is equal to or higher than the predetermined value (for example, 95%) (STEP S420). In a case where the light receiving amount rate is neither equal to nor higher than the predetermined value is determined (STEP S420, NO), the light emitting amount Le for inspection is decided again according to the similar method in STEP S410 after adjusting the platen gap to 2.0 mm (STEP S430). Also in STEP S430, in a case where the light receiving amount Lr for inspection cannot be obtained even by the maximum light emitting amount, the light emitting amount Le for inspection is not decided. In addition, the description regarding the predetermined value (STEP S420) will be made below.

Next, in at least one of the STEPs S410 and S430, whether or not the light emitting amount Le for inspection can be decided is determined (STEP S440). In a case where it is determined that the light emitting amount Le for inspection can be decided (STEP S440, YES), the platen gap is adjusted to the value in which a smaller light emitting amount Le for inspection is decided (STEP S450). In a case where only one light emitting amount Le for inspection is decided, the platen gap is adjusted to the value in which the light emitting amount Le for inspection is decided. In a case where the platen gap is adjusted to 2.0 mm, since it means that the platen gap keeps the current status, actually the adjustment of the platen gap is not performed.

Lastly, the dot inspection is performed by adopting the above-described “smaller light emitting amount Le for inspection” (STEP S480). Specifically, the dot forming inspection by the light emitting and the light receiving is performed after the dot is formed with a predetermined pattern. After that, the inspection is ended.

On the other hand, in either case where the platen gap is 2.5 mm or 2.0 mm, when it is determined that the light emitting amount Le for inspection cannot be decided (STEP S440, NO), the light emitting amount Le for inspection is decided after the platen gap is adjusted to 1.5 mm by the platen gap adjustment mechanism 270 (STEP S460). Subsequently, in STEP S460, whether or not the light emitting amount Le for inspection can be decided is determined (STEP S470). In a case where it is determined that the light emitting amount Le for inspection can be decided (STEP S470, YES), the dot inspection is performed by adopting the light emitting amount Le for inspection (STEP S480). In a case where the result in STEP S470 is YES, the gap 1.5 mm is adopted as the platen gap, and the platen gap keeps the current status.

On the other hand, even in a case where the platen gap is 1.5 mm, when it is determined that the light emitting amount Le for inspection cannot be decided (STEP S470, NO), an error message is output (STEP S490), and the inspection process is ended. Means for outputting the error message is, for example, a display or a speaker (not illustrated).

On the other hand, in a case where the platen gap is 2.5 mm, when the light receiving amount rate is equal to or higher than the predetermined value (STEP S420, YES), the dot inspection is performed by adopting the light emitting amount Le for inspection decided in STEP S410 (STEP S480). That is, the decision in STEP 430 is not performed. The predetermined value, for example, is determined based on the light receiving amount rate in the light receiving amount Lr for inspection. Specifically, in a case where the light receiving amount Lr for inspection can be sufficiently obtained despite that the light emitting amount is small, such light emitting amount is adopted as the light emitting amount Le for inspection. With respect to the light emitting amount, whether or not the light receiving amount Lr for inspection can be sufficiently obtained, for example, may be determined by verifying whether or not the light emitting amount is within the range of the predetermined amount or by comparing the light emitting amount to the light emitting amount at the time of dot inspection in the previous inspection process.

### 4. Effects

According to the embodiment described above, the durability of the light emitting element 241a may be extended. That is because, although the detection distance (the distance between the sheet surface and the light receiving element 241b) is not constant, the light emitting amount Le for inspection can be set to a value as small as possible by adjusting the platen gap. The detection distance varies depending on the variation of the thickness of the sheet and the assembling error of the printer 200. In other words, the embodiment described above has advantages in which the printing sheets P with a variety of thicknesses may be accommodated and the inspection may be performed even if there are some assembling errors.

Even in both cases where the platen gap is 2.5 mm and 2.0 mm, if the light emitting amount Le for inspection cannot be decided, the light emitting amount Le for inspection is decided in the platen gap of 1.5 mm. Therefore, it is possible to accommodate a sheet with a wide range of thickness or assembling errors.

Besides this, when the platen gap has a default value, in a case where the light receiving amount rate is equal to or higher than the predetermined value (STEP S420, YES), since the dot inspection is performed without deciding the light emitting amount Le for inspection in the other platen gap, it is possible to save time and the light emitting.

### 5. Relations between Embodiment and Application Examples

STEP S410 corresponds to the software for realizing the first decision unit, and STEP S420 and STEP 430 for the second decision unit, STEP S460 for the third decision unit and STEP S480 for the inspection unit, respectively.

The optical sensor 241, the system controller 254 and the optical sensor driver 263 correspond to the hardware for realizing the first decision unit. The motor which vertically moves the guide rail 234, the optical sensor 241, the system controller 254 and the optical sensor driver 263 correspond to the hardware for realizing the second and third decision units.

### 6. Other Embodiments

The aspects of the embodying the invention are not limited to the embodiments described above, and various embodiments may be adopted within the scope of the technology in the invention. For example, an additional one in the configuring elements of the embodiments may be omitted. The additional configuring elements described here is an element that corresponds to a matter not specified in the substantially independent application example. In addition, the embodiment described below may be adopted.

The printer 200 may not perform all the processes of dot inspection. For example, the printer 200 forms a dot on the sheet, and other apparatus (inspection apparatus) may inspect whether the dot is correctly formed or not on the dot formed sheet. In this case, the inspection apparatus performs the inspection process. However, the dot forming in the dot inspection (STEP S480) is performed by the printer 200.

In STEP S450, in a case where the ratio of the light receiving amount rate in two platen gaps is within a predetermined range, the platen gap may be adjusted to 2.5 mm. The predetermined range here is determined so that the light receiving amount rate in two platen gaps crossing over the peak is detected. As described above, that is because the light receiving amount rate gradually varies when the detection distance is long, which is preferable for the dot inspection.

STEP S420 may be omitted. Alternatively, STEP S460 and S470 may be omitted. In this case, the inspection process may be simplified.

In a case where the light emitting amount Le for inspection cannot be decided (STEP S470, NO), the dot inspection may be performed using any platen gap without outputting the error message.

The position where the optical sensor 241 is disposed on the carriage 228 may be different from the position in the embodiment, and for example, it may be disposed on upstream side in the sub-scanning direction.

The printer may adopt a line head. The line head is a printing head on which nozzles for ink ejection are disposed over the entire width of the recording width. According to this configuration, there is no need for the printing head to scan in a different direction (for example, an orthogonal direction) from the transportation direction of the printing medium.

The specific numbers in the embodiment may be changed. For example, the values of the platen gap for deciding the light emitting amount Le for inspection and the number of types of the platen gap may be changed.

What is claimed is:

1. An inspection apparatus that inspects a printed result, comprising:
a sensor that includes a light emitting element and a light receiving element;
a control unit that changes a light emitting amount received from the light emitting element;
wherein the inspection apparatus inspects the printed result using an optimal light emitting amount decided by changing the light emitting amount received from the light emitting element.

2. The inspection apparatus according to claim 1,
wherein the optimal light emitting amount is decided based on a value related to a light receiving amount received by a light receiving element with respect to the light emitting amount received from the light emitting element.

3. The inspection apparatus according to claim 1, further comprising:
a movement unit that changes a height of the sensor,
wherein the optimal light emitting amount is decided by changing the light emitting amount received from the light emitting element at different heights of the sensor.

4. The inspection apparatus according to claim 1,
wherein the optimal light emitting amount is, among the changed light emitting amounts, a minimum light emitting amount which enables the inspection of the printed result to be normally performed.

5. An inspection method comprising:
changing the light emitting amount received from a light emitting element;
measuring a light receiving amount using a light receiving element; and
inspecting a printed result using a decided optimal light emitting amount.

6. The inspection method according to claim 5,
wherein the light emitting amount received from the light emitting element is changed at different heights of the light emitting element.

7. An inspection program which causes a computer to execute:
changing a light emitting amount received from a light emitting element;
measuring a light receiving amount using a light receiving element; and
inspecting a printed result using a decided optimal light emitting amount.
